(19) United States
(12) Patent Application Publication
(10) Pub. No.: US 2024/0083282 A1
(43) Pub. Date: Mar. 14, 2024

(54) ELECTRIC VEHICLE CHARGING SYSTEM

(71) Applicant: SUBARU CORPORATION, Tokyo (JP)

(72) Inventor: Satoru ETO, Tokyo (JP)

(21) Appl. No.: 18/455,830

(22) Filed: Aug. 25, 2023

(30) Foreign Application Priority Data
Sep. 12, 2022 (JP) 2022-144329

(51) Int. Cl. B60L 53/62; B60L 53/30; B60L 53/66

(52) U.S. Cl. CPC B60L 53/62; B60L 53/305; B60L 53/66; B60L 2250/16

(57) ABSTRACT

An electric vehicle charging system that performs charging by sending/receiving a PLC signal including a CP signal between an electric vehicle with a storage battery and a charging station charging the storage battery, includes an instruction device with which a user instructs the electric vehicle to resume charging. The charging station includes an electronic control unit sending/receiving the PLC signal via a communication line. The electric vehicle includes a charger, a switch on the communication line, and a charging controller. Upon receipt of an instruction to resume charging, the charging controller allows a peak voltage of the CP signal to transition from a second voltage to a first voltage by controlling the switch to disconnect the communication line, and then allows the peak voltage of the CP signal to transition from the first voltage to the second voltage for CP reset processing, thereby resuming charging the storage battery.

### CROSS-REFERENCE TO RELATED APPLICATIONS

The present application claims priority from Japanese Patent Application No. 2022-144329 filed on Sep. 12, 2022, the entire contents of which are hereby incorporated by reference.

### BACKGROUND

The disclosure relates to an electric vehicle charging system.

One of the standards for charging storage batteries installed in electric vehicles such as plug-in hybrid vehicles and electric automobiles is the Combined Charging System (CCS) standard.

In charging under the CCS standard, charging starts when the user connects a charging station connector to an electric vehicle, and a charging station detects that the peak voltage of a control pilot (CP) signal, which is a charging control signal, has changed from 12 V to 9 V.

Therefore, if a charging error occurs and the charging is to be resumed, or if the user wants to perform additional charging after the charging has been successfully completed, it is necessary for the user to temporarily unplug the charging station connector from the electric vehicle and then plug the charging station connector back again.

In other words, after unplugging the charging station connector to allow the peak voltage of the CP signal to transition from 9 V to 12 V for CP reset processing, it is necessary to plug the charging station connector to the electric vehicle again to change the peak voltage of the CP signal from 12 V to 9 V.

However, it is bothersome for the user to manually unplug and replug the charging station connector every time the user wants to resume charging. To this end, Japanese Unexamined Patent Application Publication No. 2016-171613 discloses a technique for automatically performing CP reset processing when the charging station and the electric vehicle fall into a communication interrupted state during the charging.

In this case, by performing a switch operation inside the electric vehicle to transition the CP signal between 12 V and 9 V, the CP signal can be manipulated as if the charging station connector were temporarily unplugged and then plugged again.

### SUMMARY

An aspect of the disclosure provides an electric vehicle charging system, which is configured to perform charging by sending and receiving a power line communication (PLC) signal including a CP signal between an electric vehicle provided with a storage battery and a charging station configured to charge the storage battery via a charging station connector. The CP signal is a charging control signal. The charging system includes an instruction device with which a user is to instruct the electric vehicle to resume charging. The charging station includes an electronic control unit configured to send and receive the PLC signal via a communication line. The electric vehicle includes a charger configured to charge the storage battery by sending and receiving the PLC signal via the communication line, a switch provided on the communication line, and a charging controller configured to control the switch. The charging controller is configured to, upon receipt of an instruction to resume charging sent from the instruction device through operation by the user, allow a peak voltage of the CP signal to transition from a second voltage corresponding to a connected state of the charging station connector to a first voltage corresponding to a disconnected state of the charging station connector by controlling the switch to disconnect the communication line, and then allows the peak voltage of the CP signal to transition from the first voltage to the second voltage for CP reset processing by controlling the switch to connect the communication line, thereby resuming charging the storage battery of the electric vehicle from the charging station.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating the configuration of an electric vehicle charging system according to an embodiment;

FIG. 2 is a sequence diagram illustrating the flow of each process in a charging station, an electric vehicle, and an instruction device in charging under the CCS standard;

FIG. 3 is a diagram illustrating an example of a list of communication protocols;

FIG. 4 is a diagram illustrating an example of a list of communication protocols whose priority has been changed; and

FIG. 5 is a sequence diagram illustrating the flow of each modified process in the charging station, the electric vehicle, and the instruction device.

### DETAILED DESCRIPTION

If a charging system is configured to automatically perform CP reset processing, no CP reset processing is performed when the charging is completed successfully.

Therefore, when the user wants to perform additional charging after the charging has been completed successfully, as described above, it is necessary for the user to manually and temporarily unplug the charging station connector from the electric vehicle and then plug the charging station connector back in again.

It is desirable to provide an electric vehicle charging system capable of resuming charging a storage battery of an electric vehicle without involving the user to unplug and replug a charging station connector, in case of a charging error caused by communication interruption or the like, or when the user wants to perform additional charging.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

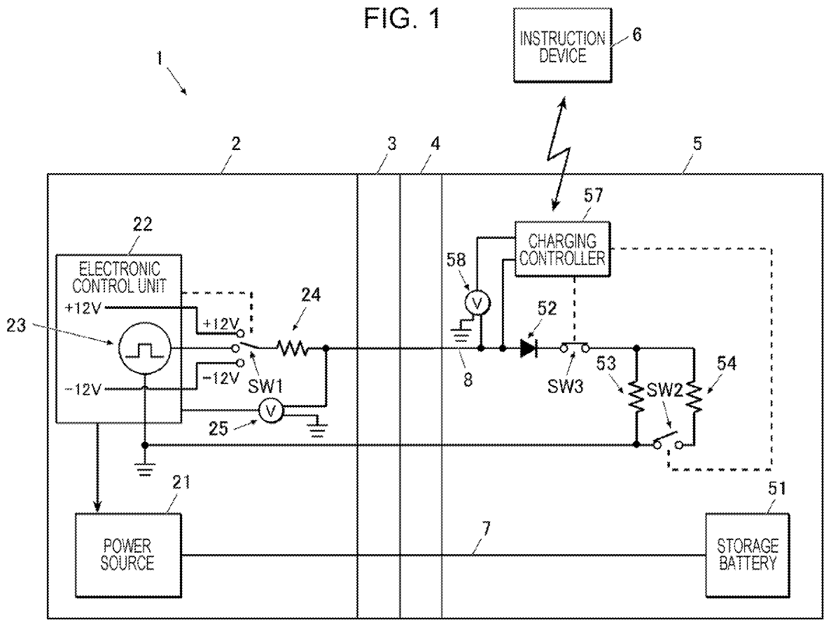

FIG. 1 is a diagram illustrating the configuration of the electric vehicle charging system according to the present embodiment. An electric vehicle charging system 1 includes a charging station 2, a charging station connector 3, a vehicle inlet 4, an electric vehicle 5, and an instruction device 6. Note that FIG. 1 illustrates a state in which the charging station connector 3 is plugged into the vehicle inlet 4.

The charging station 2 includes a power source 21 for charging, via the charging station connector 3, a storage battery 51 of the electric vehicle 5 through a power line 7.

The charging station 2 also includes an electronic control unit 22, which is configured to send and receive a PLC signal via a communication line 8 to and from the electric vehicle 5.

The PLC signal is formed by superimposing a pulse wave that has been modulated by changing the duty ratio using Pulse Width Modulation (PWM) on the CP signal, which is a rectangular wave output from an oscillator 23.

The CP signal conveys information by changing its peak voltage among a first voltage (12 V in the present embodiment), a second voltage (9 V), and a third voltage (6 V).

Moreover, the communication line 8 in the charging station 2 is provided with a first switch SW1 and a resistor 24. In the present embodiment, the resistance of the resistor 24 is 1 kΩ.

The electronic control unit 22 is capable of controlling the switching of the first switch SW1. By switching the first switch SW1, +12 V or −12 V can be applied to the resistor 24. In addition, by switching the first switch SW1 to be coupled to the oscillator 23, the CP signal and the PLC signal can be output via the communication line 8.

Therefore, in a state where the charging station connector 3 is unplugged from the vehicle inlet 4 or in the initial state immediately after the charging station connector 3 has been plugged into the vehicle inlet 4 (disconnected state), the peak voltage of the CP signal is the first voltage (12 V).

In addition, a detector 25 is coupled to the communication line 8 downstream of the resistor 24 (that is, on the electric vehicle 5 side), and, with the detector 25, the electronic control unit 22 is configured to detect the voltage value of the communication line 8 including the voltage value of the PLC signal.

The vehicle inlet 4 is provided on the electric vehicle 5, allowing plugging and unplugging of the charging station connector 3.

Although one power line 7 and one communication line 8 are illustrated in FIG. 1, multiple power lines 7 and multiple communication lines 8 may be provided, or other wiring may be provided. Although the configuration inside the charging station connector 3 and the vehicle inlet 4 is not illustrated in FIG. 1, the charging station connector 3 and the vehicle inlet 4 include necessary elements, such as switches and resistors.

The electric vehicle 5 is provided with an electric motor (not illustrated) as a power source, and is configured as a plug-in hybrid vehicle, an electric automobile, or the like.

The electric vehicle 5 includes the storage battery 51, which is charged by the power source 21 of the charging station 2 through the power line 7.

In addition, one of two ends of a resistor 53 is coupled to the communication line 8 in the electric vehicle 5 via a diode 52. The other end of the resistor 53 is grounded. In the present embodiment, the resistance of the resistor 53 is 2.74 kΩ.

Moreover, a resistor 54 is coupled to the communication line 8 in parallel to the resistor 53, and a second switch SW2 is provided between the resistor 53 and the resistor 54. In the present embodiment, the resistance of the resistor 54 is 1.3 kΩ. The second switch SW2 is normally open.

A charging controller 57 is configured to receive the PLC signal sent from the electronic control unit 22 of the charging station 2 via the communication line 8.

In addition, the charging controller 57 is configured to control turning on and off of the second switch SW2, and is configured to send the transition of a CP voltage (the voltage of the CP signal) to the electronic control unit 22 of the charging station 2 via the communication line 8 by controlling turning on and off of the second switch SW2.

Besides being able to send the transition of the CP voltage to the electronic control unit 22 of the charging station 2 via the communication line 8 as described above, the charging controller 57 is also configured to charge the storage battery 51 by sending and receiving the PLC signal.

In addition, a third switch SW3 is provided downstream of the diode 52 on the communication line 8 in the electric vehicle 5, and turning on and off of the third switch SW3 is controlled by the charging controller 57. The third switch SW3 is normally open.

Moreover, the charging controller 57 is coupled directly to the communication line 8 upstream of the diode 52 or through a detector 58. Then, the charging controller 57 detects the voltage value of the communication line 8 including the voltage value of the PLC signal by the detector 58, and is capable of communicating with the electronic control unit 22 of the charging station 2 through the communication line 8.

Note that communication from the charging controller 57 to the electronic control unit 22 of the charging station 2 may be configured to be performed using the PLC signal, or may be configured to be performed in other ways.

The electric vehicle 5 may be provided with a charger, and the charging power may be sent from the charging station 2 to the storage battery 51 via the charger, or the charging power may be sent from the charging station 2 directly to the storage battery 51 without passing through the charger. If the electric vehicle 5 includes a charger, the charger may include the charging controller 57.

In contrast, the instruction device 6 is composed of a portable device such as a smartphone or a tablet carried by the user, and is capable of communicating with the charging controller 57 of the electric vehicle 5.

Therefore, by operating the instruction device 6, the user can remotely instruct the charging controller 57 of the electric vehicle 5 to resume charging.

Next, how the storage battery 51 of the electric vehicle 5 is charged by the charging station 2 will be described mainly from the perspective of sending and receiving the PLC signal.

In the initial state, the first switch SW1 is coupled to +12 V. Thus, the voltage value of the communication line 8 in the charging station 2 (the peak voltage of the CP signal) is 12 V (first voltage).

Then, when the charging station connector 3 is plugged into the vehicle inlet 4 of the electric vehicle 5, the communication line 8 in the charging station 2 and the communication line 8 in the electric vehicle 5 are coupled to each other, allowing current to flow through the communication line 8.

Therefore, a voltage drop occurs at the resistor 24 and the resistor 53, and thus the voltage value of the communication line 8 (the peak voltage of the CP signal) drops to 9V (second voltage).

The electronic control unit 22 of the charging station 2 detects that the voltage value of the communication line 8 (the peak voltage of the CP signal) has dropped to 9 V (second voltage), thus recognizing that the charging station connector 3 has been plugged into the vehicle inlet 4 of the electric vehicle 5, and then switches the first switch SW1 to be coupled to the oscillator 23.

The electronic control unit 22 then performs initial setting by sending and receiving signals to and from the charging controller 57 of the electric vehicle 5. Note that the initial setting includes the selection of a communication protocol, which will be described later.

Then, when the initial setting is performed successfully, the charging controller 57 of the electric vehicle 5 turns on (closes) the second switch SW2. Therefore, the voltage value of the communication line 8 (the peak voltage of the CP signal) drops to 6 V (third voltage).

Upon detection that the voltage value of the communication line 8 (the peak voltage of the CP signal) has dropped to 6 V (third voltage), the electronic control unit 22 of the charging station 2 supplies power to the storage battery 51 of the electric vehicle 5 from the power source 21 through the power line 7 to start charging the storage battery 51.

Then, when the charging of the storage battery 51 is completed, the charging controller 57 turns off (opens) the second switch SW2. Therefore, the voltage value of the communication line 8 (the peak voltage of the CP signal) rises to 9 V (second voltage).

In response to detection that the voltage value of the communication line 8 (the peak voltage of the CP signal) has risen to 9 V (second voltage), the electronic control unit 22 of the charging station 2 stops the power supply from the power source 21 to end the charging of the storage battery 51 of the electric vehicle 5.

When the charging station connector 3 is unplugged from the vehicle inlet 4 of the electric vehicle 5, the current of the communication line 8 stops, and the voltage value of the communication line 8 in the charging station 2 (the peak voltage of the CP signal) rises to 12 V (first voltage).

Therefore, the electronic control unit 22 of the charging station 2 recognizes that the charging station connector 3 has been unplugged from the vehicle inlet 4 of the electric vehicle 5, and switches the first switch SW1 from being coupled to the oscillator 23 to be coupled to +12 V. In this manner, the storage battery 51 of the electric vehicle 5 is charged.

Next, processing performed by the charging controller 57 in the case of resuming charging the storage battery 51 of the electric vehicle 5 when a charging error has occurred or when the user wants to perform additional charging will be described. In addition, the operation of the electric vehicle charging system 1 according to the present embodiment will also be described.

In the embodiment of the disclosure, in such a case, the user can resume charging the storage battery 51 of the electric vehicle 5 without the necessity to unplug and replug the charging station connector 3.

As described above, the start (resumption) of charging the storage battery 51 of the electric vehicle 5 by the electronic control unit 22 of the charging station 2 is triggered by a drop in the voltage value of the communication line 8 (the peak voltage of the CP signal) from 12 V (first voltage) to 9 V (second voltage).

However, as described above, in a state where the charging of the storage battery 51 of the electric vehicle 5 has ended, the voltage value of the communication line 8 (the peak voltage of the CP signal) is 9 V (second voltage).

In addition, when a charging error has occurred, the charging controller 57 of the electric vehicle 5 is configured to turn off (open) the second switch SW2, and thus the voltage value of the communication line 8 (the peak voltage of the CP signal) becomes 9 V (second voltage).

Therefore, the voltage value of the communication line 8 (the peak voltage of the CP signal) does not reach 12 V (first voltage) in a state where the charging station connector 3 remains plugged into the vehicle inlet 4, either in the case of a charging error or when the charging has ended.

Therefore, in the current state, charging cannot resume with the charging station connector 3 left plugged into the vehicle inlet 4.

Accordingly, the charging controller 57 of the electric vehicle 5 is configured to resume charging by performing the processing as follows to raise the voltage value of the communication line 8 (the peak voltage of the CP signal) to 12 V (first voltage) while leaving the charging station connector 3 plugged into the vehicle inlet 4.

Hereinafter, the processing will be described in detail. Note that the charging station connector 3 is left plugged into the vehicle inlet 4.

When a charging error has occurred during the charging of the storage battery 51, the charging controller 57 of the electric vehicle 5 turns off the second switch SW2 as described above, and sends a notification to the instruction device 6 that a charging error has occurred.

Upon receipt of the notification from the charging controller 57, the instruction device 6 notifies the user, such as by displaying the notification on a screen, that a charging error has occurred in this case.

The charging controller 57 also turns off the second switch SW2 when the charging of the storage battery 51 has ended, and sends a notification to the instruction device 6 that the charging has ended.

Upon receipt of the notification from the charging controller 57, the instruction device 6 notifies the user, such as by displaying the notification on a screen, that the charging has ended in this case.

The user then operates the instruction device 6 to send an instruction from the instruction device 6 to the charging controller 57 of the electric vehicle 5 to resume charging in the case of resuming charging the storage battery 51 that has been suspended due to a charging error, or in the case of performing additional charging after the charging of the storage battery 51 has been completed successfully.

Then, upon receipt of the instruction to resume charging sent from the instruction device 6, the charging controller 57 controls the third switch SW3 to turn off (open) and disconnects the communication line 8.

When the communication line 8 is disconnected, no current flows through the communication line 8, and the voltage value of the communication line 8, that is, the peak voltage of the CP signal, transitions from 9 V to 12 V. That is, by turning off the third switch SW3, the peak voltage of the CP signal can be transitioned from 9 V (second voltage) corresponding to the connected state of the charging station connector 3 to 12 V (first voltage) corresponding to the disconnected state of the charging station connector 3.

In the embodiment of the disclosure, by turning off the third switch SW3 in this manner, a state as if the charging station connector 3 were unplugged from the vehicle inlet 4 is created.

Next, the charging controller 57 of the electric vehicle 5 controls the third switch SW3 to turn on (close), and connects the communication line 8.

When the communication line 8 is connected, current flows through the communication line 8, and the voltage value of the communication line 8, that is, the peak voltage of the CP signal, transitions from 12 V to 9 V. That is, by turning on the third switch SW3, the peak voltage of the CP signal can be transitioned from 12 V (first voltage) to 9 V (second voltage).

In this manner, by turning off and then on the third switch SW3, a state as if the charging station connector 3 were unplugged from the vehicle inlet 4 and then plugged to the vehicle inlet 4 again is created.

In the embodiment of the disclosure, CP reset processing can be performed while leaving the charging station connector 3 plugged into the vehicle inlet 4 of the electric vehicle 5, as described above. With the CP reset processing being performed, the charging of the storage battery 51 of the electric vehicle 5 from the charging station 2 can be resumed.

As described thus far, according to the electric vehicle charging system according to the present embodiment, when the user wants to perform additional charging, the user can resume charging the storage battery 51 of the electric vehicle 5 by simply operating the instruction device 6 to issue an instruction to resume charging, without unplugging and replugging the charging station connector 3.

Furthermore, even when a charging error occurs due to communication interruption or the like, if the user operates the instruction device 6 to issue an instruction to resume charging, the user can resume charging the storage battery 51 of the electric vehicle 5 without unplugging and replugging the charging station connector 3.

By the way, as described above, the charging controller 57 of the electric vehicle 5 performs CP reset processing in the same manner to resume charging the storage battery 51, whether to resume charging the suspended charging of the storage battery 51 due to a charging error, or to perform additional charging after the charging of the storage battery 51 has been completed successfully.

However, if the charging of the storage battery 51 just before the resumption is terminated due to a handshake error in the communication protocol between the charging station 2 and the electric vehicle 5, there is a possibility that the charging of the storage battery 51 may not resume. This point will be described hereinafter.

First, each process in the charging station 2, the electric vehicle 5, and the instruction device 6 when performing charging under the CCS standard will be described.

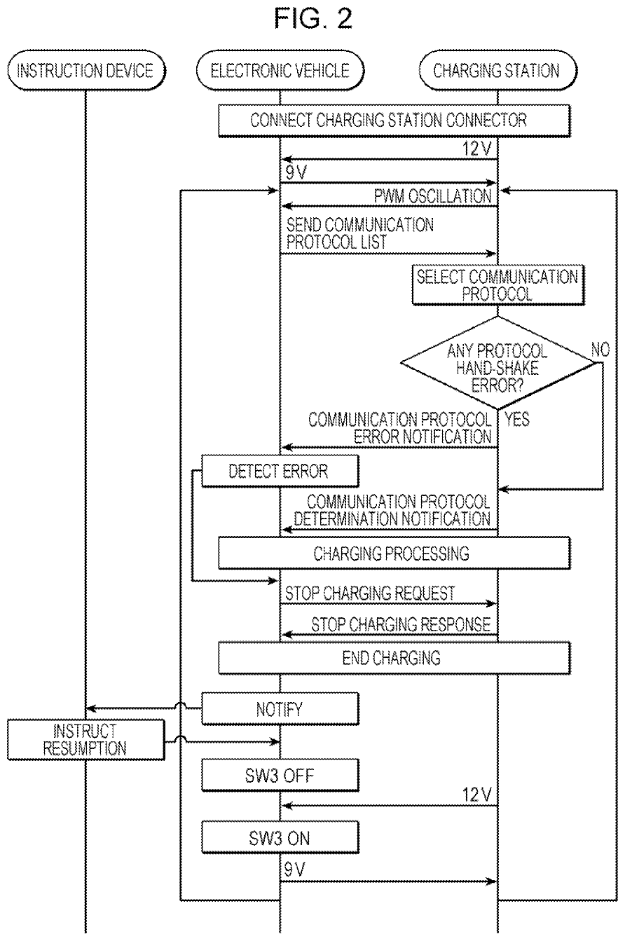

FIG. 2 is a sequence diagram illustrating the flow of each process in the charging station 2, the electric vehicle 5, and the instruction device 6 in charging under the CCS standard. Note that mainly the flow of the PLC signal is illustrated in FIG. 2.

First, when the user plugs in the charging station connector 3 to the vehicle inlet 4 of the electric vehicle 5, the communication line 8 in the charging station 2 and the communication line 8 in the electric vehicle 5 are coupled to each other.

Therefore, the voltage value of the communication line 8, that is, the peak voltage of the CP signal, drops from 12 V (first voltage) to 9 V (second voltage).

Triggered by the drop of the peak value of the CP signal to 9 V, the electronic control unit 22 of the charging station 2 sends information necessary for the initial setting to the electric vehicle 5 as a PLC signal. The PLC signal is sent superimposed on the CP signal.

Then, the charging controller 57 of the electric vehicle 5 sends a list of usable communication protocols to the charging station 2.

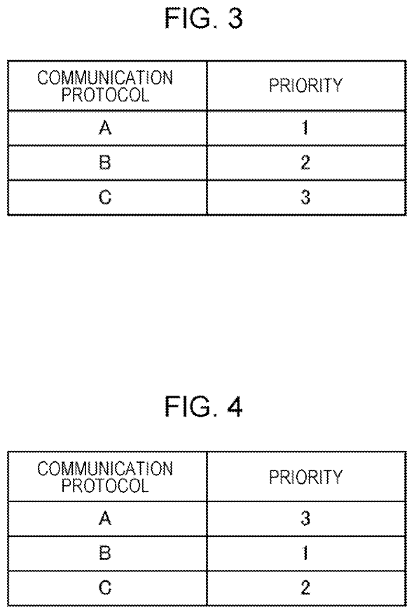

In this case, a communication protocol list L includes, for example, as illustrated in FIG. 3, all the communication protocols A to C that are usable by the electric vehicle 5.

In addition, the priority is associated with each of the usable communication protocols A to C in the list L.

The charging station 2 selects the communication protocol with the highest priority among the communication protocols supported by the charging station 2 from the list L sent. Hereinafter, the communication protocol A is assumed to have been selected.

Then, the charging station 2 notifies the electric vehicle 5 that, when the charging station 2 is able to shake hands with the selected communication protocol A (when NO is determined in the determination processing), the communication protocol has been determined to be the communication protocol A.

Then, the normal charging processing is performed, as described above.

That is, the charging controller 57 of the electric vehicle 5 turns on the second switch SW2 to drop the voltage value of the communication line 8, that is, the peak voltage of the CP signal, to 6 V (third voltage).

Triggered by this, the electronic control unit 22 of the charging station 2 then charges the storage battery 51 of the electric vehicle 5, such as by supplying power from the power source 21 to the storage battery 51 through the power line 7.

The charging controller 57 turns off (opens) the second switch SW2 to raise the voltage value of the communication line 8, that is, the peak voltage of the CP signal, to 9 V (second voltage), thereby issuing a stop charging request for the charging station 2.

After the electronic control unit 22 of the charging station 2 responds to the electric vehicle 5 to stop charging, the electronic control unit 22 ends the charging of the storage battery 51 of the electric vehicle 5, such as by stopping the power supply from the power source 21 to the storage battery 51.

When the charging ends, the charging controller 57 of the electric vehicle 5 sends a notification to the instruction device 6 that the charging has ended.

Upon receipt of the notification from the charging controller 57, the instruction device 6 notifies the user, such as by displaying the notification on a screen, that the charging has ended.

Here, when the user unplugs the charging station connector 3 from the vehicle inlet 4 of the electric vehicle 5, the series of processes for charging the storage battery 51 of the electric vehicle 5 ends.

In contrast, when the user, who wants to perform additional charging, operates the instruction device 6 to issue an instruction to resume charging the storage battery 51 of the electric vehicle 5, as described above, the charging controller 57 of the electric vehicle 5 controls the third switch SW3 to turn off (open).

This disconnects the communication line 8, and the voltage value of the communication line 8, that is, the peak voltage of the CP signal, transitions to 12 V (first voltage).

Next, the charging controller 57 of the electric vehicle 5 controls the third switch SW3 to turn on (close), which in turn transitions the peak voltage of the CP signal to 9 V (second voltage).

In this manner, the additional charging is performed by resuming each process from the initial setting processing (transmitting the PLC signal superimposed on the CP signal).

In the resumed process, the charging station 2 similarly selects the communication protocol A. Because the charging station 2 is able to shake hands with the communication protocol A (NO is determined in the determination processing), communication can be performed between the charging station 2 and the electric vehicle 5 using the communication protocol A. Therefore, the additional charging of the storage battery 51 is performed successfully.

In contrast, when the user plugs in the charging station connector 3 to the vehicle inlet 4 of the electric vehicle 5 and the charging station 2 first selects the communication protocol A but fails to shake hands with the communication protocol A (YES is determined in the determination processing), a problem may arise.

In this case, as illustrated in FIG. 2, the charging station 2 notifies the electric vehicle 5 that a communication protocol error (a handshake error in the communication protocol) has occurred.

Therefore, the charging controller 57 of the electric vehicle 5 detects that a communication protocol error has occurred, and issues a stop charging request for the charging station 2 by raising the peak voltage of the CP signal to 9 V (second voltage), without performing the charging processing of the storage battery 51.

After the electronic control unit 22 of the charging station 2 responds to the electric vehicle 5 to stop charging, the electronic control unit 22 ends the charging of the storage battery 51 of the electric vehicle 5, such as by stopping the power supply from the power source 21 to the storage battery 51.

When the charging is suspended as above, the charging controller 57 of the electric vehicle 5 sends a notification to the instruction device 6 that the charging of the storage battery 51 has been suspended due to a charging error.

Upon receipt of the notification from the charging controller 57, the instruction device 6 notifies the user, such as by displaying the notification on a screen, that the charging of the storage battery 51 has been suspended due to a charging error.

Here, when the user unplugs the charging station connector 3 from the vehicle inlet 4 of the electric vehicle 5, the charging processing ends without charging the storage battery 51 of the electric vehicle 5.

In contrast, when the user, who wants to resume charging the storage battery 51 of the electric vehicle 5, operates the instruction device 6 to issue an instruction to resume charging the storage battery 51 of the electric vehicle 5, a problem may arise as follows.

That is, in this case, as described above, when the charging controller 57 of the electric vehicle 5 controls the third switch SW3 to turn on and off, each process is resumed from the initial setting, as described above.

However, because the charging station 2 selects the communication protocol A in the resumed process, the charging station 2 is unable to shake hands with the selected communication protocol A (YES is determined in the determination processing).

Then, in the above-described embodiment, as long as the user operates the instruction device 6 to issue an instruction to resume charging without unplugging the charging station connector 3 from the vehicle inlet 4 of the electric vehicle 5, the state in which the charging station 2 is unable to shake hands with the communication protocol A continues.

Therefore, the charging station 2 and the electric vehicle 5 cannot communicate with each other forever, and the storage battery 51 cannot be charged.

Accordingly, as described above, in charging the storage battery 51 of the electric vehicle 5, when the charging ends (suspended) due to a handshake error in the communication protocol between the charging station 2 and the electric vehicle 5, the charging controller 57 of the electric vehicle 5 may be configured to change the communication protocol.

That is, when the charging ends due to a communication protocol error, if the user issues an instruction to resume charging, the charging controller 57 of the electric vehicle 5 may be configured to change the priority of each communication protocol in the communication protocol list L, as illustrated in FIG. 4.

With such a configuration, when resuming charging the storage battery 51 in response to a communication protocol error, the communication protocol selected by the charging station 2 is changed from the previous communication protocol A to the communication protocol B.

Therefore, although the charging station 2 was unable to shake hands with the communication protocol A, the charging station 2 may be able to shake hands with the communication protocol B, and thus the above problem due to a communication protocol error may be avoided.

When the charging of the storage battery 51 has been completed successfully and when the user has issued an instruction to resume charging in order to perform additional charging, there is no need to change the communication protocol since no communication protocol error has occurred.

Therefore, it is desirable to configure the charging controller 57 of the electric vehicle 5 to change the priority of each communication protocol only in the case where a communication protocol error has occurred.

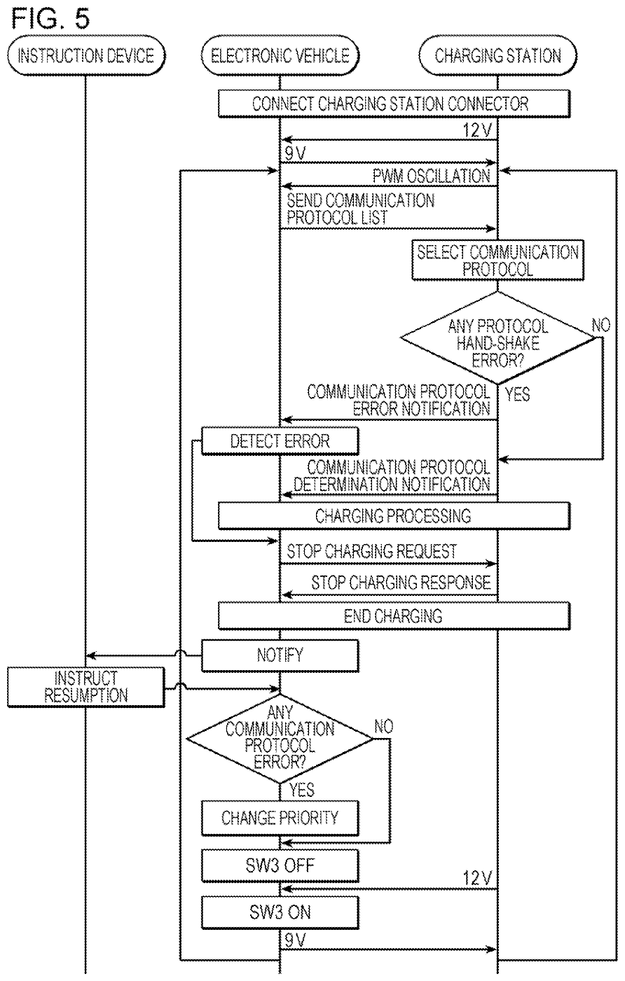

To that end, the processing sequence illustrated in FIG. 2 is modifiable, for example, as illustrated in FIG. 5.

Note that, in the sequence diagram illustrated in FIG. 5, a description of the same processing as that in the sequence diagram illustrated in FIG. 2 will be omitted.

Upon receipt of an instruction from the instruction device 6 to resume charging the storage battery 51 of the electric vehicle 5, the charging controller 57 of the electric vehicle 5 is configured to determine whether there is a notification of a communication protocol error from the charging station 2 in the immediately preceding sequence.

In other words, upon receipt of an instruction to resume charging sent from the instruction device 6 through operation by the user, the charging controller 57 determines whether the charging has ended due to a handshake error in the communication protocol between the charging station 2 and the electric vehicle 5 during the immediately preceding charging of the storage battery 51.

Then, when YES is determined in the determination processing, the charging controller 57 changes the priority of each communication protocol from the priority illustrated in FIG. 3 to the priority illustrated in FIG. 4, for example.

In the meantime, when NO is determined in the determination processing, the charging controller 57 can be configured so as not to change the priority of each communication protocol.

With such a configuration, the charging controller 57 is able to change the communication protocol when the charging has ended due to a handshake error in the communication protocol.

Therefore, if the charging station 2 is able to shake hands with the changed communication protocol, CP reset processing may be performed to resume charging the storage battery 51 of the electric vehicle 5 from the charging station 2.

Moreover, when no handshake error occurs in the communication protocol between the charging station 2 and the electric vehicle 5 during the immediately preceding charging of the storage battery 51, the communication protocol is left unchanged.

Therefore, the charging controller 57 is able to continuously use the communication protocol with which the charging station 2 is able to shake hands (the communication protocol A in the above example). Then, CP reset processing is performed while communicating with the charging station 2, which allows the charging of the storage battery 51 of the electric vehicle 5 from the charging station 2 to resume (additional charging in this case).

Needless to say, the embodiment of the disclosure is not limited to the above-described embodiment, and is suitably changeable unless it does not deviate from the spirit of the embodiment of the disclosure.

1. An electric vehicle charging system configured to perform charging by sending and receiving a power line communication (PLC) signal including a control pilot (CP) signal between an electric vehicle provided with a storage battery and a charging station configured to charge the storage battery via a charging station connector, the CP signal being a charging control signal, the electric vehicle charging system comprising:
an instruction device with which a user is to instruct the electric vehicle to resume charging, wherein:
the charging station includes an electronic control unit configured to send and receive the PLC signal via a communication line;
the electric vehicle comprises a charger configured to charge the storage battery by sending and receiving the PLC signal via the communication line, a switch provided on the communication line, and a charging controller configured to control the switch; and
the charging controller is configured to upon receipt of an instruction to resume charging sent from the instruction device through operation by the user, allow a peak voltage of the CP signal to transition from a second voltage corresponding to a connected state of the charging station connector to a first voltage corresponding to a disconnected state of the charging station connector by controlling the switch to disconnect the communication line, and then allow the peak voltage of the CP signal to transition from the first voltage to the second voltage for CP reset processing by controlling the switch to connect the communication line, thereby resuming charging the storage battery of the electric vehicle from the charging station.

2. The electric vehicle charging system according to claim 1, wherein:
the charging controller is configured to, when a charging error has occurred, send a first notification to the instruction device that the charging error has occurred, and
the instruction device is configured to, upon the receipt of the notification from the charging controller, notify the user that the charging error has occurred.

3. The electric vehicle charging system according to claim 1, wherein:
the charging controller is configured to, when charging has ended, send a second notification to the instruction device that charging has ended, and
the instruction device is configured to, upon receipt of the second notification from the charging controller, notify the user that charging has ended.

4. The electric vehicle charging system according to claim 1, wherein:
the charging controller is configured to, when, upon the receipt of the instruction to resume charging sent from the instruction device through operation by the user, charging ends due to a handshake error in a communication protocol between the charging station and the electric vehicle during immediately preceding charging of the storage battery, change the communication protocol, and then perform the CP reset processing to resume charging the storage battery of the electric vehicle from the charging station.

5. The electric vehicle charging system according to claim 1, wherein:
the charging controller is configured to, when, upon the receipt of the instruction to resume charging sent from the instruction device through operation by the user, no handshake error has occurred in a communication protocol between the charging station and the electric vehicle during immediately preceding charging of the storage battery, perform the CP reset processing to resume charging the storage battery of the electric vehicle from the charging station, without changing the communication protocol.
